(19) United States
(12) Patent Application Publication
(10) Pub. No.: US 2005/0024651 A1
(43) Pub. Date: Feb. 3, 2005

(54) Adaptive complexity scalable post-processing method

(76) Inventors: Zhenghua Yu, North Epping (AU); Jian Zhang, Enfield (AU); Reji Mathew, Riverwood (AU)

Correspondence Address: DANIEL K. NICHOLS;Motorola, Inc. - Law Department, 1303 E. Algonquin Road, Schaumburg, IL, 60196, US

(21) Appl. No.: 10/631,038

(22) Filed: Jul. 29, 2003

(51) Int. Cl. G06T 5/00; H04N 1/409; H04N 1/405; H04N 1/60; H04N 1/393

(52) U.S. Cl. 358/1.9; 382/268; 358/518; 358/1.2; 358/3.13; 358/1.13; 358/3.24; 358/3.26; 382/261

(57) ABSTRACT

The invention provides a system and a method suitable for adaptive post-processing of media data in an electronic device. The system comprises one or more post-processing modules (102,104,106,108,110) that perform post-processing of the media data. Each post-processing module comprises one or more processing modes having different complexities. The system also comprises an adaptive mode decision module (112) coupled to the post-processing modules (102,104,106,108,110). The adaptive mode decision module (112), in use, decides upon the suitable processing modes on the basis of values of one or more input parameters. The input parameters are representative of the state of the electronic device. Once the decision has been made, the adaptive mode decision module (112) sends control signals to the post-processing modules (102,104,106,108,110) in order perform the post-processing of the media data according to the selected processing modes.

### FIELD OF THE INVENTION

The present invention relates to the post-processing of media data. The invention is particularly useful for, but not necessarily limited to, providing scalable complexity levels in post-processing stages in a mobile device.

### BACKGROUND OF THE INVENTION

Over recent years, mobile devices have developed from being voice-based devices to advanced devices with multimedia capabilities. To enable multimedia applications such as videos, still images, and the like, encoding and decoding of digital media data is usually required.

Encoding of reference or original digital media data is required to compress the amount of digital media before transmission, and the encoded data is decoded by a receiving device to provide a representation of the original digital media data. Examples of well-known techniques used for encoding and achieving compression are JPEG (Joint Photographic Experts Group) for images and MPEG (Moving Pictures Experts Group) for video data. These techniques use block transform coding, which involves dividing an image into blocks of equal size and processing each block independently. One of the transforms used for such encoding is the Discrete Cosine Transform (DCT) in which the image is divided into a collection of identically sized rectangles. The image data within each rectangle is transformed to provide a sequence of DCT coefficients. This sequence is then quantized and encoded to reduce the size of the data that needs to be transmitted. When the degree of compression is low, the loss of information in the decoded image is negligible. However, when a large degree of compression is needed, the compression may result in the original information being permanently lost. Thus, the original image cannot be perfectly reconstructed from the compressed version. In this case, the loss of the information becomes apparent with the occurrence of visible artifacts because of the block nature of the encoding and the quantization of the DCT coefficients. The artifacts are external elements introduced in the decoded image that were not present in the original image. Examples of artifacts that may occur in the decoded images are blocking artifacts and ringing artifacts. Blocking artifacts occur where the outlines of the encoding blocks appear as distinct transitions, superimposed on the image from one block to another. Ringing artifacts occur where bright areas are adjacent to dark ones and these artifacts appear as a spatial oscillation in brightness. Elimination of such artifacts is desirable to obtain an image/video of sufficiently good quality upon decoding.

The above artifacts can be removed by performing post-processing on the decoded digital media data. The term post-processing refers to additional processing steps that are performed after the basic decoding processing steps. Deblocking and deringing techniques are often used to eliminate blocking and ringing artifacts. In addition, other techniques such as Color Space Conversion (YUV to RGB), Image Resizing and Dithering are used to prepare the digital media data for display. Color space conversion from YUV to RGB desirable to obtain image/video having a rich color from a ‘reduced color information form’ used in most mobile devices. Here, Y represents Y channel Luma, which is the signal seen by black and white televisions; U and V represent the Cb and Cr channels respectively; and RGB represents the three primary colors Red, Green and Blue. Image resizing involves changing the size of an image that is, either increasing or decreasing the size of the image, which is particularly useful when the size of the original image is different from that of the display. Dithering is a technique used to improve image quality when limited display resources (such as less number of bits used for quantization of the image or less number of colors used than present in the input image) are used for image display. These techniques are implemented as separate stages during the post-processing of the decoded media data.

Although, the post-processing stages mentioned above improve the image quality, they have a high computational complexity and hence require significant processor time. Therefore, if all the stages in the post-processing chain are performed, the total processor usage during post-processing may be several times that required during the decoding processing steps of the digital media data.

The high computational complexity of the post-processing stages may not always be suitable for mobile devices that typically have limited battery power. Further, the processing capability in a mobile device is much smaller, compared for example, to that of a desktop computer. Therefore, the set of post-processing stages if carried out in a mobile device may hinder the normal functioning of the mobile device. Further, if the processor in the mobile device is performing other tasks that are of a higher importance than the post-processing of the image/video, it might be preferred to reduce the time allocated in the processor for performing the post-processing. In addition, the greater the number of post-processing stages implemented in the mobile device, the greater is the overall complexity of the post-processing. In such a case, the overall quality of the image/video is higher, but this comes at the price of reduced overall performance and increased battery drain. Accordingly, there should be an adaptive trade-off between the quality of post-processed media data against, amongst others, battery drain and device performance.

### SUMMARY OF THE INVENTION

The current invention provides a system and a method suitable for adaptive post-processing of media data in an electronic device. The system comprises a set of post-processing modules and an adaptive mode decision module to control the post-processing modules. Each post-processing module implements a post-processing task. The post-processing modules may include a deblocking module, a deringing module, a color space conversion module, an image-resizing module, and a bit reduction and dithering module. Each post-processing module processes the media data using one or more methods referred to as processing modes.

The adaptive mode decision module comprises an input module, a table module, and an output module. The input module provides the adaptive mode decision module with a set of input parameters. The input parameters are representative of the state of the electronic device. The table module defines suitable processing modes of the post-processing modules corresponding to the possible values of the input parameters. The output module uses the input parameters and the table module to decide upon the suitable processing modes. Further, the output module generates the control signals that implement the suitable processing modes in the post-processing modules.

Once the table module is generated, the adaptive mode decision module is used to control the post-processing of the media data. The input module obtains the input parameters and sends the values of the input parameters to the output module. This is a continuous monitoring process, that is, the current values of the input parameters are continuously obtained and sent to the output module. The output module makes a decision on the complexity level of the processing modes to be chosen from the table module on the basis of the values of the input parameters. After a decision on the choice of complexity level is made, the output module generates control signals that are sent to the post-processing modules. These control signals choose the processing mode in each post-processing module. Finally, the post-processing modules perform the post-processing of the media data according to the selected processing modes.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a block diagram of the system for post-processing, in accordance with an embodiment of the current invention;

FIG. 2 is a block diagram of an adaptive mode decision module, in accordance with an embodiment of the current invention;

FIG. 3 is a block diagram of the deblocking module with sub-stages and the adaptive mode decision module controlling the different sub-stages, in accordance with an embodiment of the current invention;

FIG. 4 is a flowchart of the steps comprised in the generation of a table relating processing modes and values of input parameters;

FIG. 5 shows a table that is used in an embodiment of the present invention;

FIG. 6 shows a user interface enabling a user to give his/her preference of the quality of the post-processing; and

FIG. 7 is a flowchart illustrating a method of adaptive post-processing of media data, in accordance with the present invention.

### DETAILED DESCRIPTION OF THE PREFERRED EMBODIMENT OF THE INVENTION

The present invention discloses a system and a method for adaptive post-processing of media data.

The invention is used in an electronic device having capability to process the media data. The electronic device may be any device with a processor. The invention can be used with both mobile devices and non-mobile devices. The non-mobile devices comprise portable DVD players, video-telephony terminals, personal computers, digital televisions and other electronic devices that use a processor. Specifically, the operation of the invention is described with reference to a mobile device. The mobile device refers to all mobile devices that use a portable battery as a power source. Examples of the mobile device include devices such as a mobile phone, a PDA (Personal Digital Assistant), a laptop, a tablet PC and the like. The mobile device receives and/or stores encoded media data. The media data refers to all kinds of image and video data and their possible combinations. The standard techniques used for encoding of the media data are based on JPEG for images and MPEG for video data. Other similar techniques may also be used to encode the media data. The encoded media data is decoded at the mobile device, when the media data is required to be displayed to the user. The decoded media data contains visible artifacts as a result of quantization and “lossy” compression techniques used for encoding. Examples of visible artifacts are blocking artifacts and ringing artifacts. The visible artifacts are required to be eliminated from the media data to improve the quality of the decoded media data. To achieve this improvement in the quality, the decoded media data is passed through a set of post-processing modules implemented in the mobile device.

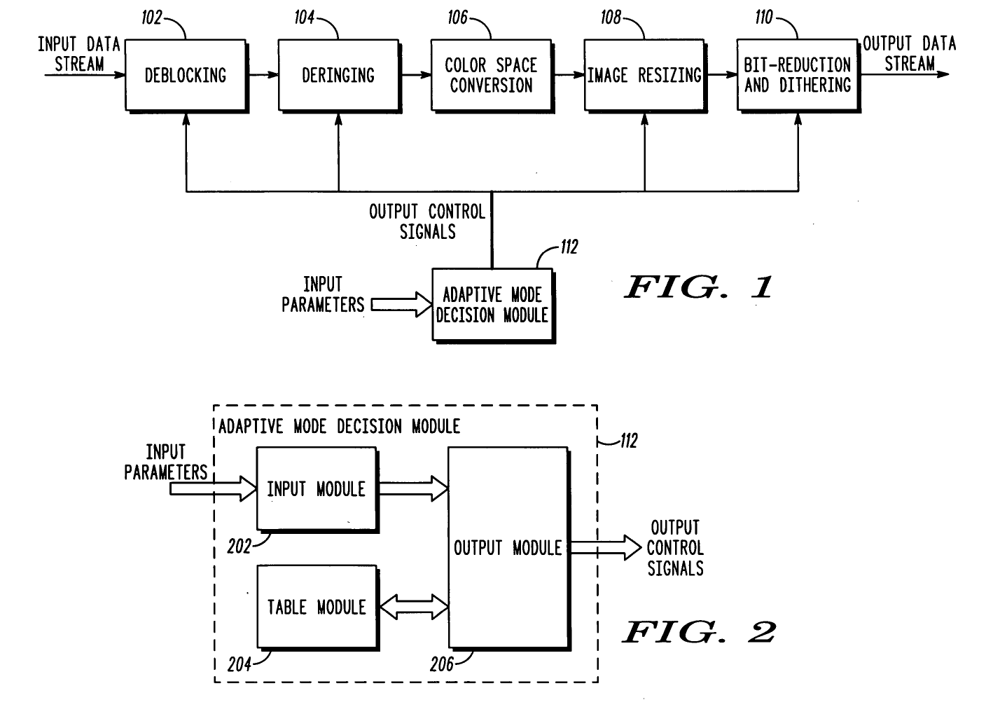

FIG. 1 is a block diagram of the system for post-processing, in accordance with an embodiment of the current invention. FIG. 1 illustrates a set of post-processing modules that are used to process decoded media data to improve the quality of the media data. The chain of post-processing modules comprises a deblocking module 102, a deringing module 104, a color space conversion module 106, an image-resizing module 108 and a bit reduction and dithering module 110. Each post-processing module implements a post-processing task. Deblocking module 102 reduces blocking artifacts in the decoded media data. Deringing module 104 reduces ringing artifacts. Color space conversion module 106 converts the media data from a reduced color information form to a rich color information form. Image-resizing module 108 accomplishes changing the size of an image in the media data. Bit reduction and dithering module 110 improves the quality of the decoded image when limited resources are used for image display (such as less number of bits and less number of colors). An adaptive mode decision module 112 controls the post-processing modules on the basis of input parameters by means of control signals. The input parameters are representative of the state of the electronic device on which the system is implemented. In the exemplary set of post-processing modules illustrated in FIG. 1, the media data enters deblocking module 102 and is processed sequentially in each of the post-processing modules in accordance with the control signals generated by the adaptive mode decision module 112.

In an embodiment, each of the post-processing modules can implement more than one method of post-processing called a post-processing mode. For example, in the exemplary set of post-processing modules described in FIG. 1, deblocking module 102 performs deblocking using one from amongst three different processing modes. The three processing modes have different computational complexities and yield deblocking results with different qualities. Further, the post-processing performed by deblocking module 102 can be categorized into sub-stages. The sub-stages depend on the particular method used for deblocking. Similarly, the other post-processing modules can implement one or more processing modes.

Adaptive mode decision module 112 receives the input parameters and decides upon the set of processing modes based on the input parameters. Then, adaptive mode decision module 112 sends out control signals that implement the decided post-processing mode for each post-processing module. The stream of the input media data is then processed according to the processing modes.

FIG. 2 is a block diagram of adaptive mode decision module 112. Adaptive mode decision module 112 comprises an input module 202, a table module 204 and an output module 206. Input module 202 is connected to output module 206 and provides the input parameters to output module 206. Input module 202 constantly monitors the input parameters and provides the current values of the input parameters to output module 206. Table module 204 defines the suitable processing modes of the post-processing modules corresponding to the possible values of the input parameters. Output module 206 uses the values of the input parameters and the suitable processing modes in table module 204 to select one of the suitable processing modes. Further, output module 206 generates and sends the control signals that implement the decided processing modes in the post-processing modules.

In this embodiment of the current invention, an exemplary set of input parameters may be: remaining battery power of the mobile device, processor usage of the processor in the mobile device, and user preference. The remaining battery power parameter is a measure of the total amount of power left in the battery of the mobile device. The processor usage is an indication of the load on the processor because of the applications already running on the mobile device. As will be apparent to a person skilled in the art, input module 202 is enabled with the capability of measuring the remaining battery power and the processor usage. Further, the user preference can be provided by means of a user interface that allows the user to exercise the option of choosing or influencing the processing modes. It should be apparent to one skilled in the art that other input parameters, representing the state of the mobile device, can also be used in the current invention.

As mentioned earlier, each of the post-processing modules can have multiple processing modes and therefore, each post-processing module is able to process the media data with different complexities. Further, adaptive mode decision module 112 makes a decision on the processing modes of the post-processing modules on the basis of the input parameters. This is done using table module 204.

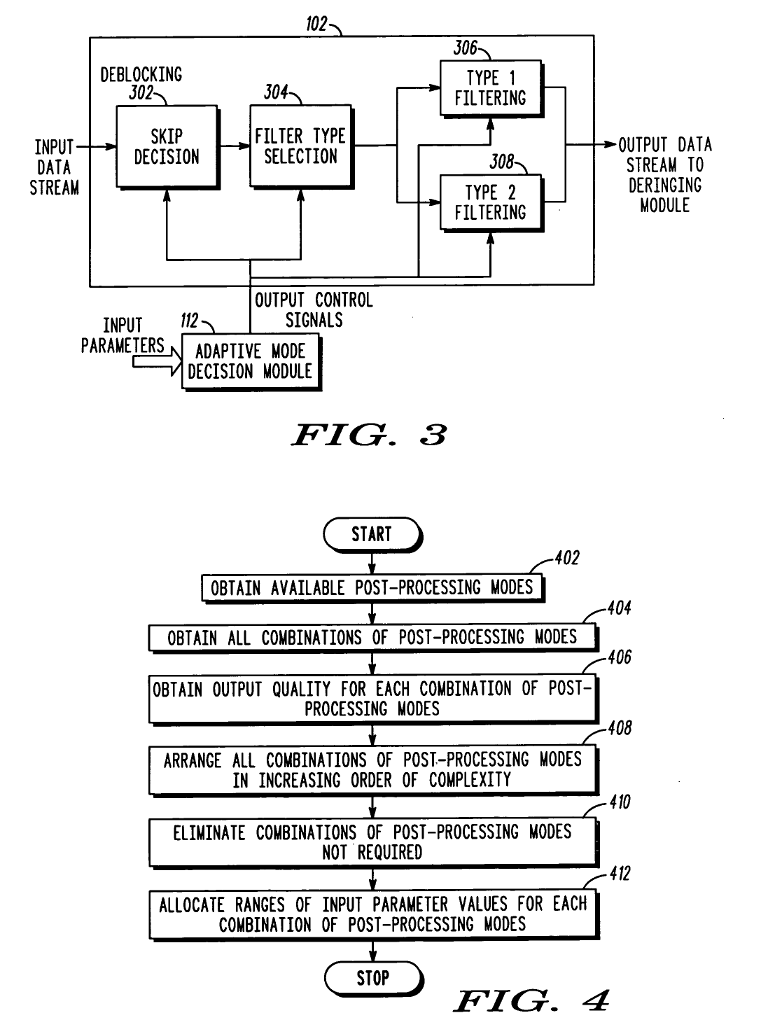

FIG. 3 shows a detailed version of deblocking module 102 with sub-stages and adaptive mode decision module 112, operatively coupled to and providing signals/commands for controlling the different sub-stages. Deblocking module 102 comprises a skip decision stage 302 that decides whether to perform the deblocking operation or not. Skip decision stage 302 is connected to filter type selection stage 304. Filter type selection stage 304 achieves variable complexity on the basis of threshold values. The type of filter is selected on the basis of the characteristics of the input media data against a pre-defined threshold value. The threshold values are pre-determined on the basis of experiments. An exemplary implementation for filter type selection, known in the prior art, is disclosed in research paper titled ‘A Deblocking Filter with Two Separate Modes in Block-Based Video Coding’, authored by Sung Deuk Kim, Jaeyoun Yi, Hyun Mun Kim and Jong Beom Ra, and published in ‘IEEE Transactions on Circuits and Systems for Video Technology’, Vol. 9, No. 1, February 1999, pp. 156-160. In the research paper, the flatness of a region is examined according to the number of pixel pairs, where the pixel value difference between a pair of pixels is less than a threshold, say threshold A. The number is further compared against another threshold, say threshold B, to decide whether the region is flat. Different deblocking filters are applied to flat and non-flat regions.

There are three possible complexity levels in case of filter type selection: high complexity, low complexity and bypass. Different complexities in filter type selection stage 304 are obtained by adjusting the thresholds. Filter type selection stage 304 selects one of the two filters: type 1 filtering stage 306 or type 2 filtering stage 308. As an example, type 2 filtering stage 308 is assumed to filter more pixels and use a longer filter tap, and hence can perform filtering of a higher complexity. Type 1 filtering stage 306 filters fewer pixels and uses shorter filter tap, and hence performs filtering of a lower complexity. As an example, consider two possible values of threshold B, viz. 4 and 6. By making threshold B value equal to 6, more pixels can be assigned to type 1 filtering stage 306, which leads to low complexity. On the other hand, making threshold B value equals to 4 leads to high complexity. If filter type selection stage 304 is bypassed, then all pixels are assigned to type 1 filtering stage 306, which leads to the lowest complexity. Type 1 filtering stage 306 is implemented using two filters: Filter 1 and Filter 1A, the complexity of Filter 1A being lower than that of Filter 1. Further, type 1 filtering stage 306 can also be bypassed. Type 2 filtering stage 308 is implemented using two filters: Filter 2 and Filter 2A, the complexity of Filter 2A being lower than that of Filter 2. Further, type 2 filtering stage 308 can also be bypassed. The complexity of Filter 2A is greater than that of Filter 1. Examples of the filters are shown below:

$$Filter 1 A : \\ {v}_{i}^{′} = {\sum }_{k = - 1}^{1} {v}_{i + k} {h}_{k} , 4 \leq i \leq 5$$

$$\{ {h}_{k} , - 1 \leq k \leq 1 \} = \{ 1 , 2 , 1 \} \text{//} 4$$

$$Filter 1 : \\ {v}_{i}^{′} = {\sum }_{k = - 2}^{2} {v}_{i + k} {h}_{k} , 3 \leq i \leq 6$$

$$\{ {h}_{k} , 2 \leq k \leq 2 \} = \{ 1 , 1 , 4 , 1 , 1 \} \text{//} 8$$

$$Filter 2 A : \\ {v}_{i}^{′} = {\sum }_{k = - 3}^{3} {v}_{i + k} {h}_{k} , 2 \leq i \leq 7$$

$$\{ {h}_{k} , - 3 \leq k \leq 3 \} = \{ 1 , 1 , 1 , 2 , 1 , 1 , 1 \} \text{//} 8$$

$$Filter 2 : \\ {v}_{i}^{′} = {\sum }_{k = - 3}^{3} {v}_{i + k} {h}_{k} , 1 \leq i \leq 8$$

$$\{ {h}_{k} , - 3 \leq k \leq 3 \} = \{ 1 , 1 , 1 , 2 , 1 , 1 , 1 \} \text{//} 8 , where$$

$${v}_{i} denotes the value of pixel i before filtering ;$$

$${h}_{k} denotes the impulse response of the filter used ;$$

$${v}_{t}^{′} denotes the value of pixel i after filtering ; and$$

a block edge resides between pixels 4 and 5, where a block edge is an artificial edge of adjacent pixel values introduced by a blocking artifact.

FIG. 3 shows how a particular module, deblocking module 102 in the above case, has multiple processing modes of performing the particular post-processing task. Other processing modules can also have more than one processing modes of operation. Deblocking module 102 has processing modes for each stage as described with reference to FIG. 3. Deringing module 104 has three processing modes. The complexity of processing modes in deringing module 104 can be varied by adjusting thresholds. An exemplary implementation for obtaining the thresholds, known in the prior art, is disclosed in a standard titled ‘Information technology—Generic coding of audio-visual objects—Part 2’ published in ISO/IEC IS 14496, Visual, 1999, Annex F.-2 In the standard, the thresholds are calculated according to the characteristics of the input image data. If maximum[k] is the maximum pixel value in block k, and minimum[k] is the minimum pixel value in block k, the threshold of block k can be represented as
thr[k]=(maximum[k]+minimum[k]+1)/2*c,
where c is a variable used to adjust the threshold.

Ringing pixels are detected according to the threshold thr[k]. Varying c (for example, being 0.5, 1, and 1.5, respectively) leads to varying number of ringing pixels being detected and filtered, hence leading to varying complexities. Image-resizing module 108 has two processing modes viz. nearest neighbor interpolation and bi-linear interpolation. Nearest neighbor interpolation selects those source pixels that most closely line up with the output pixel grid as output pixels. Bilinear interpolation in one direction (horizontal or vertical) is a weighted average between two closest source pixels or lines. More information on nearest neighbor interpolation and bi-linear interpolation can be obtained from the book by R. C. Gonzalez and R. E. Woods titled ‘Digital Image Processing’, published by Addison Wesley in 1993. Dithering module 110 has two processing modes viz. on and bypass. In bypass mode, if color depth reduction is required, least significant bits of pixel values are simply dropped to match the color depth of the display. When dithering is turned on, more complex algorithms such as error diffusion technique can be applied to improve the visual quality. Error diffusion attempts to choose the pattern of lighted display cells in such a way as to minimize the average error between the input and the displayed intensity. More information on dithering can be obtained from the book by A. N. Netravali and B. G. Haskell titled ‘Digital Pictures: Representations, Compression, and Standards’ published by Plenum Press in 1994.

Different combinations of the various processing modes (corresponding to the different post-processing modules) can be formed to perform post-processing on the media data that is input as a data stream. The output quality of the media data obtained after passing the media data through the post-processing modules depends on the processing modes chosen for the post-processing. Therefore, different levels of quality can be obtained using different combinations of processing modes.

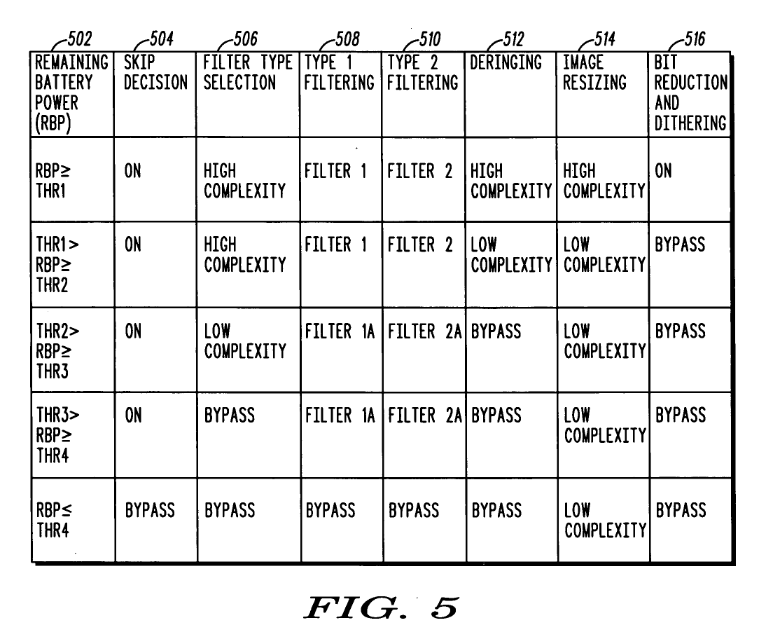

FIG. 4 is a flowchart illustrating the steps comprised in the generation of a table that relates the processing modes with the values of the input parameters. The combinations of the processing modes belonging to different post-processing modules are stored in a table along with corresponding possible values of input parameters. The table can be generated as follows. At step 402, all the processing modes that the post-processing modules can use are obtained. At step 404, all the possible combinations of the processing modes are obtained. Each combination is obtained by choosing one processing mode from each post-processing module. Next, at step 406, the output quality of the media data for each combination of processing modes is obtained. The output quality for each combination is obtained by processing the media data using the processing modes applicable for that combination. The output quality can be measured through subjective or objective assessment of the output media data. An example method of subjective assessment is double-stimulus impairment scale variant II (DSIS II). This method is described as a standard in the document titled ‘Methodology for the Subjective Assessment of the Quality of Television Pictures’ in ITU-R BT 500-9, ITU, Geneva, Switzerland, 1974-1998. PSNR (Peak Signal to Noise Ratio) as well as some recent more advanced methods provide means to assess media quality objectively. One such method is described in Video Quality Experts Group Draft, titled “Final Report from the Video Quality Experts Group on the Validation of Objective Models of Video Quality Assessment”, Phase II, 2003. Complexity may be assessed by benchmarking the execution time of the selected post-processing combination on the target platform with those test video sequences that are frequently used in the field, such as those used by MPEG.

At step 408, the combinations of processing modes are arranged in an increasing order of the complexity of the combination. Each combination of processing modes is called a complexity level. After such an order is achieved, there can be some complexity levels that have a higher complexity and a lower output quality compared to another complexity level. All such complexity levels with higher complexity and lower output quality are eliminated, at step 410. After this, what remains is a list of complexity levels with increasing complexity and increasing output quality. This list enables one to choose a complexity level corresponding to a desired output quality. The greater the number of complexity levels, the smaller is the difference in quality and complexity between two successive complexity levels. Therefore, there is a gradual increase in the output quality from one complexity level to another complexity level with higher complexity. Finally, at step 412, the complexity levels are related to the range of values of the input parameters. Adaptive mode decision module 112 chooses the complexity level corresponding to the range in which the input parameter lies. Considering the case when the remaining battery power is the input parameter, ranges of the remaining battery power are to be assigned to each complexity level. This can be done in several ways depending on the preference of the person implementing the invention on the mobile device. In one embodiment, the range of the remaining battery power is equally divided into the number of complexity levels. That is, if there are five different complexity levels, the range of the remaining battery power is divided into five equal parts. In other cases, the thresholds chosen for each complexity level can be varied according to the preference of the person implementing the invention.

FIG. 5 shows a table generated using the method described in FIG. 4. The first column, column 502 lists the remaining battery power. The other seven columns, columns 504-516 list the processing modes for all the stages and post-processing modules. There are five different complexity levels in the five rows arranged in an increasing order from bottom to top. The first column gives the ranges of remaining battery power corresponding to each complexity level. Threshold levels Thr1 to Thr4 define the range in each complexity level. These threshold levels are decided by the person implementing the invention on the mobile device. As already described, in one embodiment, the threshold levels can be chosen so as to divide the remaining battery power in five equal ranges. Such a table is generated for the other input parameters as well. The tables, as generated, are stored in table module 204.

In one embodiment, the input parameters are remaining battery power, processor usage and user preference. There are three tables relating the values of the input parameters to the complexity levels obtained as described above. The range of each input parameter corresponding to each complexity level is decided. The complexity levels are obtained as described earlier. Further, for the input parameter user preference, the user is given a choice using a graphical interface.

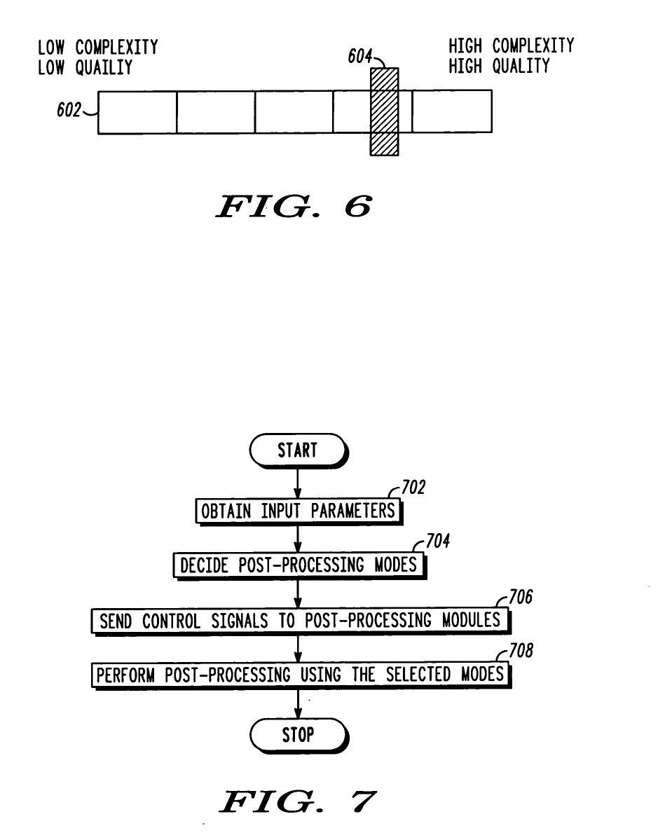

FIG. 6 shows a user interface enabling a user to give his/her preference of the desired quality of the media data. The user interface comprises a bar 602 and choice cursor 604. Bar 602 is divided into five parts, which correspond to the five quality levels. The complexity of the post-processing and the quality of the media data increases from left to right. A user can choose the level of complexity and quality according to his/her preference using choice cursor 604.

FIG. 7 shows a flowchart illustrating a method of adaptive post-processing of media data. At step 702, input module 202 obtains values of one or more input parameters, the input parameters being representative of the state of the electronic or mobile device. Exemplary input parameters are remaining battery power, processor usage and user preference. The remaining battery power can be obtained by measuring the voltage and the current that is supplied by the battery of the mobile device. The processor usage can be measured by measuring the percentage of the total processor time that all the applications being run by the processor use. This is a continuous monitoring process. That is, the values of the input parameters are monitored on a continual basis and provided to input module 202. At step 704, the processing mode is decided by output module 206 receiving the input parameters obtained by input module 202. Further, output module 206 compares the values of the input parameters with the values in table module 204. Output module 206 then decides on an appropriate complexity level. The method of choosing the complexity level on the basis of the input parameters and table module 204 may be decided by the person implementing the invention. In one embodiment, output module 206 takes the value of each input parameter one at a time and chooses the corresponding complexity level from table module 204. If there are three input parameters, the complexity level with the least complexity is chosen for the post-processing. For example, where the input parameters are remaining battery power, processor usage, and user preference, then the complexity levels allowed may be of fourth highest, third highest and fifth highest complexity respectively (as previously illustrated in FIG. 5). In this case, the complexity level with third highest complexity is used for post-processing the media data. In another embodiment, the invention can be implemented giving a greater preference to one of the input parameters. For example, if the highest priority is given to the user preference, the complexity level based on the user preference is used irrespective of the other input parameters. If the user does not give any preference, the minimum complexity level allowed by the other input parameters is chosen for post-processing the media data. After a decision on the choice of complexity level is made, output module 206, at step 706, generates the control signals CS that are sent to the post-processing modules. These control signals CS choose the processing mode in each post-processing module. Hence, essentially steps 704 and 706 perform obtaining values of one or more input parameters, the input parameters being representative of the state of the electronic device; and selecting suitable processing modes for the post-processing modules, the selection being based on the values of the input parameters and the complexity of the processing modes.

Finally, at step 708, the post-processing modules perform the post-processing of the media data according to a selected one of the suitable processing modes.

The system provided by current invention is adaptive in the sense that the system takes account of any change in the values of input parameters during the post-processing of the media data. The system makes a corresponding change in the complexity level of the post-processing modules in accordance with the detected change. In such case, adaptive mode decision module 112 adapts to the change and performs the post-processing with the new complexity level. For example, during post-processing, if the remaining battery power falls below a particular threshold level, adaptive mode decision module 112 chooses another complexity level having a lower complexity that is suitable for the present value of the input parameters. On the other hand, if initially the processor usage in the mobile device is high but sometime later, the processor usage decreases, adaptive mode decision module 112 chooses another complexity level with a higher complexity that is suitable for the present value of the input parameters. In the examples, a change in only one input parameter value is described. However, it would be apparent to one skilled in the art that the system of the current invention can be configured to perform even if more than one input parameter values change simultaneously.

Since the invention uses table module 204, which relates the complexity levels of the processing modes with the input parameter values, it enables one to choose the complexity level for any desired value of power consumption. This is because, the complexity levels in the tables in table module 204 are listed in a decreasing order of complexity and quality, as shown in FIG. 5. The greater is the complexity of the processing modes, the greater is the power consumption in the processing mode. Therefore, the power requirements also vary in the same order. If the user wants to limit the power consumption to a particular value, the user can choose a complexity level with the required power consumption.

The present invention can be implemented both in hardware and software embodiments. Adaptive mode decision module 112 can be implemented in hardware in the form of an ASIC (Application Specific Integrated Circuit) or as a FPGA (Field Programmable Gate Array). Adaptive mode decision module 112 can also be implemented in software using any of the well-known programming languages. Table module 204 that stores the table and forms a part of adaptive mode decision module 112 may be implemented in the form of any computer readable memory. The post-processing modules may be implemented in the form of either hardware or software. The post-processing modules used in the invention and their implementations are well known in the art.

The present invention has several advantages. First, the invention enables the post-processing of the media data with variable complexity of the post-processing stages. Secondly, the invention achieves an optimum output quality of the media data on the basis of the input parameters. The input parameters are obtained through constant monitoring and are representative of the state of the electronic device. The invention is adaptive to the changing values of the input parameters. Thirdly, the invention enables the post-processing of the media data on the basis of input parameters such as the remaining battery power and the processor usage and the user preference. Finally, the invention does not depend on any particular post-processing module or any method used in the post-processing module. In other words, the invention can be used for performing adaptive and variable complexity post-processing of the media data irrespective of the methods used, as long as there are two or more different processing modes.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

1. A system suitable for adaptive post-processing of media data in an electronic device, the system comprising:
a. one or more post-processing modules, the post-processing modules performing post-processing of the media data, each post-processing module comprising one or more processing modes with different complexities; and
b. an adaptive mode decision module coupled to the post-processing modules, wherein the adaptive mode decision module decides suitable processing modes to be used in the post-processing modules, the decision being based on one or more values of input parameters, the input parameters being representative of the state of the electronic device.

2. The system as recited in claim 1 wherein the adaptive mode decision module comprises:
a. an input module, the input module receiving the input parameters;
b. a table module relating the processing modes of the post-processing modules and all possible values of the input parameters; and
c. an output module coupled to the input module and the table module, the output module selecting the suitable processing modes of the post-processing modules.

3. The system as recited in claim 1 wherein one of the input parameters is remaining battery power of the electronic device.

4. The system as recited in claim 1 wherein one of the input parameters is processor usage of the electronic device.

5. The system as recited in claim 1 wherein one of the input parameters is user preference, the user preference indicating choice of output quality of the media data.

6. A method of adaptive post-processing of media data in an electronic device, the post-processing being performed using one or more post-processing modules, the post-processing modules comprising one or more processing modes with different complexities, the method comprising:
a. obtaining values of one or more input parameters, the input parameters being representative of the state of the electronic device;
b. selecting suitable processing modes for the post-processing modules, the selection being based on the values of the input parameters and the complexity of the processing modes; and
c. performing the post-processing of the media data using a selected one of the suitable processing modes.

7. The method as recited in claim 6 wherein obtaining the values of one or more input parameters comprises continuously monitoring the values of the input parameters.

8. The method as recited in claim 6 wherein the method further comprises generating a table, the table defining the suitable processing modes to be used for a given range of input parameter values.

9. The method as recited in claim 8 wherein generating the table comprises:
a. obtaining the processing modes available in the post-processing modules;
b. obtaining all combinations of processing modes, each combination containing one processing mode from each processing module;
c. obtaining output quality for each combination of the processing mode;
d. arranging the combinations of processing modes in increasing order of complexity;
e. eliminating the combinations that do not give higher quality compared to the combinations having lower complexity; and
f. allocating ranges of input parameter values for each combination of processing modes.

10. The method as recited in claim 7 wherein obtaining the input parameters comprises obtaining remaining battery power in the electronic device.

11. The method as recited in claim 7 wherein obtaining the input parameters comprises obtaining processor usage of the electronic device.

12. The method as recited in claim 7 wherein obtaining the input parameters comprises obtaining user preference, the user preference indicating desired output quality of the media data.

13. The method as recited in claim 7 wherein selecting the suitable processing modes comprises:
a. for each input parameter value, obtaining a combination of processing modes to be used;
b. determining an overall complexity for each of the combinations corresponding to the input parameter values; and
c. selecting the combination of the processing modes having minimum overall complexity.

14. A computer program product for use with a computer, the computer program product comprising a computer usable medium having a computer readable program code embodied therein for adaptive post-processing of media data in an electronic device, the post-processing being performed using one or more post-processing modules, the post-processing modules comprising one or more processing modes with different complexities, the computer program code performing:
a. obtaining one or more input parameters, the input parameters influencing the post-processing of the media data;
b. selecting suitable processing modes for the post-processing modules, the selection being based on the input parameters and the complexity of the processing modes; and
c. performing post-processing of the media data using the suitable processing modes.

15. The computer program product as recited in claim 14 wherein the computer program code for obtaining the values of one or more input parameters comprises a computer program code for continuously monitoring the values of the input parameters.

16. The computer program product as recited in claim 14 wherein the computer program code for selecting the suitable processing modes comprises a computer program code for generating a table, the table defining the suitable processing modes to be used for a given range of input parameter values.

17. The computer program product as recited in claim 16 wherein the computer program code for generating the table comprises a computer program code for:
a. obtaining the processing modes available in the post-processing modules;
b. obtaining all combinations of processing modes, each combination containing one processing mode from each processing module;
c. obtaining output quality for each combination of the processing mode;
d. arranging the combinations of processing modes in increasing order of complexity;
e. eliminating the combinations that do not give higher quality compared to the combinations having lower complexity; and
f. allocating ranges of input parameter values for each combination of processing modes.

18. The computer program product as recited in claim 14 wherein the computer program code for obtaining the input parameters comprises a computer program code for obtaining remaining battery power in the electronic device.

19. The computer program product as recited in claim 14 wherein the computer program code for obtaining the input parameters comprises a computer program code for obtaining processor usage of the electronic device.

20. The computer program product as recited in claim 14 wherein the computer program code for obtaining the input parameters comprises a computer program code for obtaining user preference, the user preference indicating desired output quality of the media data.

21. The computer program product as recited in claim 14 wherein the computer program code for selecting the suitable processing modes comprises a computer program code including:
a. obtaining a combination of processing modes to be used for each input parameter value;
b. determining an overall complexity for each of the combinations corresponding to the input parameter values; and
c. selecting the combination of the processing modes having minimum overall complexity.
